(19) United States
(12) Patent Application Publication
(10) Pub. No.: US 2009/0208772 A1
(43) Pub. Date: Aug. 20, 2009

(54) METHOD OF WELDING THREE METAL SHEETS AND APPARATUS WITH THREE STACKED METAL SHEETS

(75) Inventor: Alexander D. Khakhalev, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/033,432

(22) Filed: Feb. 19, 2008

(51) Int. Cl. B32B 15/01; B23K 11/14

(52) U.S. Cl. 428/594; 219/117.1

(57) ABSTRACT

A method of manufacturing welded metal sheets is presented that leaves exposed (i.e., visible) surfaces of the sheets substantially free of any weld marks following welding, without any additional steps performed at the area of the weld following the weld. Thus, manufacturing efficiency may be increased and costs lowered. An apparatus with three stacked metal sheets which may be welded according to the method of manufacturing is also disclosed herein.

### TECHNICAL FIELD

The invention relates to a method of welding three metal sheets and an apparatus formed using the same.

### BACKGROUND OF THE INVENTION

Welding operations are often utilized as a means for connecting metal components. There are many types of welding processes, such as spot welding, laser welding, and friction stir welding. Typically, weld marks are apparent at the area of a weld due to the high temperatures and physical changes in the material following a weld. Therefore, it is often necessary to perform “clean-up” processes following welding in order to minimize the appearance of the weld marks, especially in applications where the aesthetic appearance of the welded component is important. Such additional processes increase manufacturing time and cost.

### SUMMARY OF THE INVENTION

A method of manufacturing welded metal sheets is presented that leaves exposed (i.e., visible) surfaces of the sheets substantially free of any weld marks, without any additional steps performed at the area of the weld following the weld. Thus, manufacturing efficiency may be increased and costs reduced. An apparatus with three stacked metal sheets which may be welded according to the method of manufacturing is also disclosed.

The method of manufacturing includes forming a first projection portion extending from one side of a first metal sheet, and a second projection portion extending from an opposing side of the same first metal sheet. The projection portions may be formed to a desired shape using a punch and die set. Prior to forming the projections, the metal sheets may be coated, such as with a zinc coating, for corrosion protection. Under the method, the first metal sheet with the projections formed thereon is placed between a second and a third metal sheet (i.e., the sheets are stacked) such that the first projection portion extends toward an inner surface of the second metal sheet and the second projection portion extends toward an inner surface of the third metal sheet. Next, welding electrodes are placed adjacent the metal sheets, in alignment with the projection portions. The first metal sheet is then welded to the second and third metal sheets at the projection portions. The exposed outer surfaces of the second and third metal sheets are substantially free of weld marks, because the projection portions weld to inner surfaces of the second and third sheets. The substantial absence of weld marks is also due to the weld parameters enabled under the method, such as utilizing welding electrodes with substantially flat weld contact areas that span the entire width of the area of the inner sheet having the projection portions, which distributes heat and force more evenly, energizing the electrodes for not more than about 4 milliseconds, and using a weld force of not more than about 200 pounds also contributes to the absence of weld marks. At most, the method may result in a surface depression on the outer surfaces of the second and third metal sheets of not more than 0.1 millimeters, much less than the 0.3 to 1.0 millimeter depressions typically resulting from welding processes. Furthermore, because of the relatively short weld time, no cooling period or cooling processes are required before the welding electrodes may be reused to weld another area of the stacked sheets or another set of stacked metal sheets, such as on a production line. The method may be especially useful for automotive body panels, home appliances, and other products with high surface appearance requirements.

Pursuant to the method, an apparatus may be produced that includes three stacked metal sheets including two outer metal sheets juxtaposed on either side of an inner metal sheet. The inner metal sheet has a first projection portion extending toward an inner surface of one of the outer metal sheets and a second projection portion extending toward another inner surface of the other outer metal sheet. The inner surfaces of the outer metal sheets are welded to the inner metal sheet at the respective projection portions such that the outer surfaces of the outer sheets are characterized by a substantial absence of weld marks. The projection portions may have different shapes that are configured to enhance the goal of achieving a secure weld without substantially affecting the visible appearance of the outer sheets. For example, triangular or rounded extensions may be used. Also, two projection portions may extend toward one of the outer sheets on either side of another projection portion extending toward the other outer metal sheet. This balanced design may help to alleviate any twisting of the inner metal sheet that may occur during formation of the projection portions.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in side view of a projection welding system including three stacked metal sheets with an inner sheet having a first embodiment of opposing projection portions with a substantially triangular shape;

FIG. 2 is a schematic illustration in cross-sectional side view of the three stacked metal sheets of FIG. 1;

FIG. 3 is a schematic illustration in cross-sectional side view of a die set used to form the projection portions in the inner sheet of FIGS. 1 and 2;

FIG. 4 is a schematic illustration in cross-sectional side view of a second embodiment of three stacked metal sheets with an inner sheet having opposing projection portions of a substantially rounded shape;

FIG. 5 is a schematic illustration in cross-sectional view of a third embodiment of three stacked metal sheets with an inner sheet having opposing projection portions of substantially triangular shape with one extending toward an upper sheet and two extending toward a lower sheet;

FIG. 6 is a schematic illustration in plan view of the inner metal sheet of FIGS. 1 and 2 showing the opposing projections;

FIG. 7 is a schematic illustration in cross-sectional view of the three stacked metal sheets of FIGS. 1, 2 and 6 after welding;

FIG. 8 is a schematic illustration in plan view of the welded metal sheets of FIG. 7 illustrating the absence of weld marks on an exposed outer surface of the upper sheet; and

FIG. 9 is a flow chart illustrating a method of welding metal sheets

### DESCRIPTION OF THE PREFERRED EMBODIMENTS

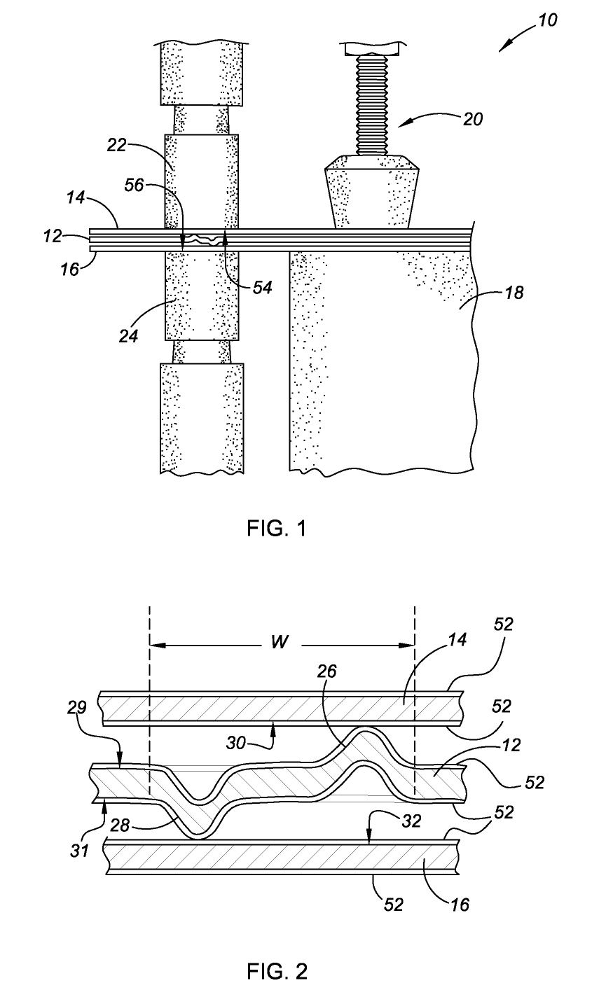

Referring to the drawings, wherein like reference numbers refer to like components, FIG. 1 shows a projection welding system 10 capable of welding three stacked metal sheets together without leaving weld marks on the exposed outer surfaces of the outer sheets, as described below. The stacked metal sheets include an inner sheet 12 nested between two outer sheets 14, 16. The stacked metal sheets 12, 14, 16 are held securely between a stationary member 18 and an adjustable clamp 20. Welding electrodes 22, 24 are placed in contact with the outer sheets 14, 16. Due to the special construction of the inner sheet 12 and the electrodes 22, 24, the welding process secures the sheets 12, 14, 16 to one another in an efficient and dependable manner, with evidence of the weld being nearly invisible on the exposed surfaces of the connected metal sheets 12, 14, 16.

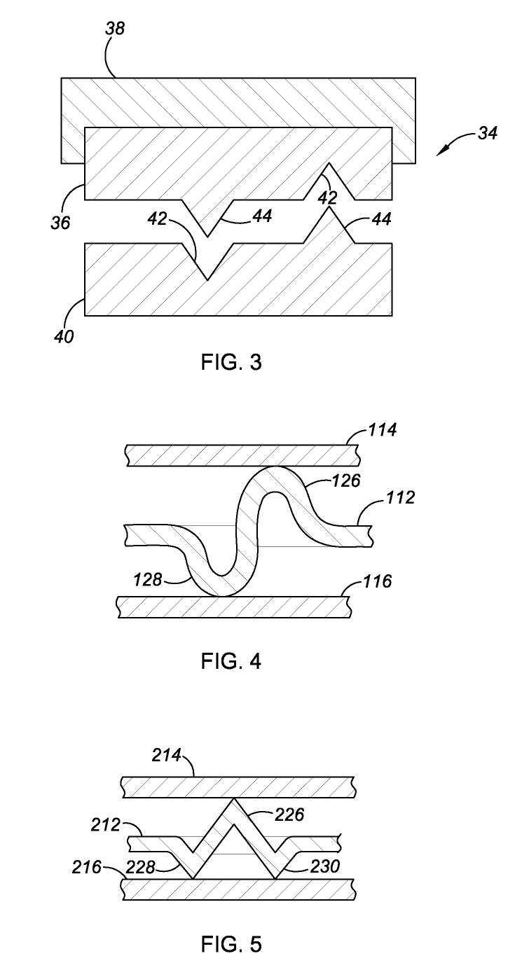

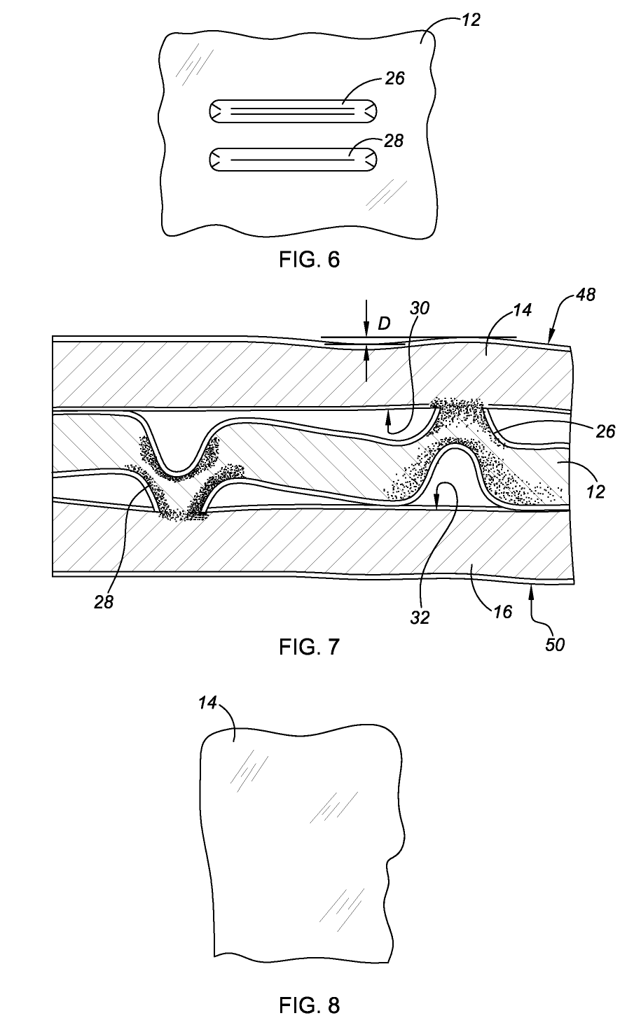

Referring to FIG. 2, a cross-sectional view of the stacked sheets 12, 14, 16, prior to welding, reveals first and second projection portions 26, 28 formed in the inner metal sheet 12. The first projection portion 26 is substantially triangular in shape and extends outward from surface 29 of inner sheet 12 toward an inner surface 30 of metal sheet 14. The second projection portion 28 is also substantially triangular in shape and extends outward from surface 31 of inner sheet 12 toward an inner surface 32 of metal sheet 16. Referring to FIG. 3, a die set 34 used to form the projection portions 26, 28 on the inner sheet 12 includes a punch 36 movable by action of an upper die 38 toward a lower die 40 such that substantially triangular cavities 42 and formations 44 create the projection portions 26, 28 in the inner sheet 12 when the previously flat inner sheet 12 of FIGS. 1 and 2 is placed between the upper and lower dies 38, 40. Referring to FIG. 6, the inner sheet 12 is shown from above and rotated 90 degrees with respect to FIG. 2. The first projection portion 26 appears as an elevation while the second projection portion 28 appears as a depression. Each of the sheets 12, 14, 16 is preferably but not necessarily coated with a zinc coating 52 on either side thereof, as illustrated in FIG. 2, to improve corrosion resistance as well as to promote the ability to draw the projection portions 26, 28.

Referring again to FIG. 1, the electrodes 22, 24 are specifically designed with a substantially flat contact portion 54, 56, respectively, that spans the width W (see FIG. 2) of the inner sheet 12 from the beginning to the end of the projection portions 26, 28. The flat contact portions 54, 56 allow current flowing through the electrodes 22, 24 (when energized) to be distributed across the entire width W of the projection portions 26, 28, better distributing the heat and force load of the electrodes 22, 24, to achieve a secure weld, as illustrated in FIG. 7, with the first projection portion 26 melting into the inner surface 30 of metal sheet 14 and the second projection portion 28 melting into the inner surface 32 of metal sheet 16. A force load of 200 pounds with current applied for 4 milliseconds was found to achieve welds of sufficient integrity for uses such as in automotive body panels. As shown in FIG. 7, a surface depression D of 0 to 0.1 mm is formed at the outer surface 48 of outer sheet 14. This surface affect is not apparent in the schematic plan view of sheet 14 in FIG. 8. The deformation of outer surface 50 of outer sheet 16 is similarly no more than a 0.1 mm depression in the area of the weld. The minimal surface depression achieved with the projection welding methods described herein is a function of the force applied to the stack of sheets 12, 14, 16 with the electrodes 22, 24, the relatively short time span for which current is applied, and the electrode conditions. Neither the length of time of applied current nor the temperature of the metal sheets 12, 14, 16 at the area of the projection portions 26, 28 where the weld occurs are factors affecting surface depression D. The weld time and temperature are minimal in comparison to other welding techniques. These factors affecting surface depression with the present method and system are in contrast to the greater number of factors affecting surface depression with typical resistance welding, which typically runs between 0.3 to greater than 1 millimeter. For such typical welding processes, in addition to weld force, applied current and electrode conditions, such factors also include welded metal properties, the length of time the current is applied, the angle of the weld (i.e., angle of the electrodes relative to the metal sheets), the electrode size, and the quality of the electrode dressing, as is understood by those skilled in the art.

Projection portions of various shapes may be used equally as well as the triangular projection portions 26, 28. For example, FIG. 4 shows another embodiment of stacked metal sheets 112, 114, 116, shown prior to welding. The inner metal sheet 112 is formed with projection portions 126, 128 which are substantially rounded. Such projection portions 126, 128 may be formed using a die pair similar to that of FIG. 3 with differently shaped cavities and formations, as is well understood by those skilled in the art. FIG. 5 shows yet another embodiment of stacked sheets 212, 214, 216 within the scope of the invention. In this embodiment, a first projection portion 226 extends toward an inner surface of the metal sheet 214, a second projection portion 228 extends toward the inner surface of the metal sheet 216, and a third projection portion 230 extends toward the inner surface of the metal sheet 216, with the first projection portion 226 being between the projection portions 228 and 230. The addition of projection portion 230 may alleviate twisting of the inner metal sheet 212 in the area of the projection portions 226, 228, 230 about the plane formed by the inner metal sheet 212 in comparison to embodiments with only two projection portions. Either of the embodiments of FIGS. 4 and 5 may be used in the projection welding system 10 of FIG. 1 in lieu of stacked sheets 12, 14, 16 to accomplish the welding with virtually no weld marks apparent on the exposed outer surfaces of the outer sheets 114, 116 and 214, 216, respectively.

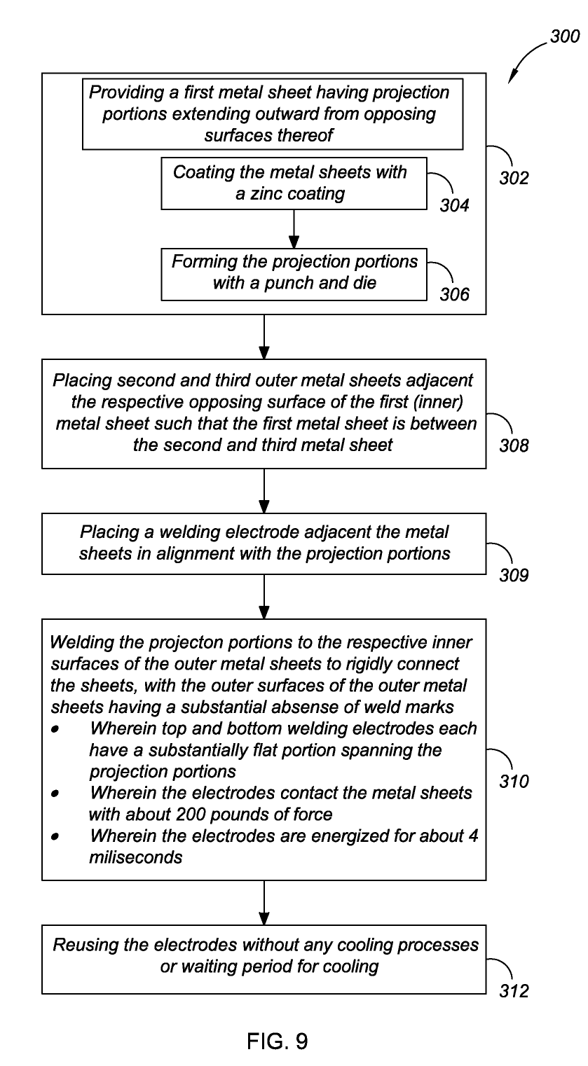

Referring to FIG. 9, a method of welding metal sheets 300 is described for purposes of discussion with respect to the projection welding system 10 of FIG. 1 and the stacked metal sheets 12, 14, and 16. However, it should be understood that the method 300 is not limited to use with these particular devices and components. The method 300 includes step 302, providing a first metal sheet (inner metal sheet 12) having projection portions 26, 28, extending outward from opposing surfaces 29, 31, respectively. Step 302 may optionally include step 304, coating the metal sheets 12, 14, 16 with coating, such as a zinc coating. Step 302 may also includes as step 306, forming the projection portions with a punch and die, following step 304. Steps 304 and 306 may alternatively be performed by one or more different entities than the entity undertaking step 302.

Following step 302, the method 300 includes step 308, placing second and third outer metal sheets 14, 16 adjacent the respective opposing surfaces 29, 31 of the first (inner) metal sheet 12 to form a set of stacked sheets. Next, the method 300 includes step 309, placing welding electrodes 22, 24 adjacent the metal sheets 12, 14, 16 in alignment with the projection portions 26, 28. Steps 308 and 309 are in preparation for step 310, welding the projection portions 26, 28 to respective inner surfaces 30, 32 of the outer metal sheets 14, 16. Step 310 is accomplished such that the outer surfaces 48, 50 of the outer sheets 14, 16 are left with a substantial absence of weld marks following the weld (i.e., with no more than a surface depression D (of FIG. 7) in the range of 0-0.1 mm). Notably, step 310 may be carried out with welding electrodes 22, 24 having substantially flat contact portions 54, 56 spanning the projection portions 26, 28, with a weld force of approximately 200 pounds and the electrodes 22, 24 energized for approximately 4 milliseconds. Because step 310 may be carried out with such a relatively low weld force and duration, the electrodes may be reused in step 312 for another welding operation, such as welding a subsequent set of stacked metal sheets, or a subsequent set of projections on the same stacked metal sheets, without any specific cooling processes or cooling period necessary prior to the reuse.

While the best modes for carrying out the invention have been described in detail, those familiar with the art to which this invention relates will recognize various alternative designs and embodiments for practicing the invention within the scope of the appended claims.

1. A method of manufacturing welded metal sheets comprising:
forming a first projection portion extending from one side of a first metal sheet and a second projection portion extending from an opposing side of the first metal sheet;
placing the first metal sheet between a second and a third metal sheet such that the first projection portion extends toward an inner surface of the second metal sheet facing the first metal sheet and the second projection portion extends toward an inner surface of the third metal sheet facing the first metal sheet;
placing welding electrodes adjacent the metal sheets in alignment with the projection portions; and
welding the first metal sheet to the second and third metal sheets at the projection portions such that exposed outer surfaces of the second and third metal sheets are substantially free of marks from the welding.

2. The method of claim 1, wherein said welding is characterized by energizing the electrodes for not more than about 4 milliseconds.

3. The method of claim 1, wherein the welding electrodes contact the metal sheets with a force of not more than approximately 200 pounds during the welding.

4. The method of claim 1, wherein the second and third metal sheets are characterized by a surface depression caused by the welding of not more than 0.1 mm.

5. The method of claim 1, further comprising:
prior to said deforming, coating each of said metal sheets.

6. A method comprising:
providing a first metal sheet having projection portions extending outward from opposing surfaces thereof,
placing second and third outer metal sheets adjacent the respective opposing surfaces of the first metal sheet such that the metal sheets are stacked with the first metal sheet positioned as an inner metal sheet between the second and third outer metal sheets and the projection portions extending toward respective inner surfaces of the second and third outer metal sheets; and
welding the projection portions to the respective inner surfaces of the second and third outer metal sheets such that the metal sheets are rigidly connected to one another and the outer surfaces of the second and third outer metal sheets are characterized by a substantial absence of marks due to the welding.

7. The method of claim 6, wherein said providing includes:
forming the projection portions with a punch and die configured to provide the projections with a desired shape.

8. The method of claim 6, wherein the welding is via electrodes each having substantially flat contact portions spanning the projections.

9. The method of claim 6, wherein said providing includes:
coating the sheets prior to forming the projection portions.

10. The method of claim 6, wherein the welding includes contacting the metal sheets with an electrode with approximately 200 pounds of force.

11. The method of claim 6, wherein said welding is via electrodes each having a relatively flat contact portion; and wherein said welding is characterized by energizing electrodes for about 4 milliseconds; and further comprising:
reusing the electrodes to weld other projection portions on the same or different metal sheets without any cooling processes or required waiting period for cooling the electrodes.

12. An apparatus comprising:
three stacked metal sheets including two outer metal sheets juxtaposed on either side of an inner metal sheet; wherein the inner metal sheet is characterized by a first projection portion extending toward an inner surface of one of the outer metal sheets and a second projection portion extending toward another inner surface of the other outer metal sheet; and wherein the inner surfaces of the outer metal sheets are welded to the inner metal sheet at the respective projection portions such that outer surfaces of the outer sheets are characterized by a substantial absence of weld marks.

13. The apparatus of claim 12, wherein the projecting portions are substantially triangular in cross-section.

14. The apparatus of claim 12, wherein the projecting portions are substantially rounded in cross-section.

15. The apparatus of claim 12, wherein the inner metal sheet is further characterized by a third projection portion extending in the same direction as the first projecting portion with the second projecting portion between the first and third projecting portions.

16. The apparatus of claim 12, further comprising:
a coating on each of the metal sheets.

17. The apparatus of claim 12 in combination with welding electrodes having substantially flat contact portions configured to span a width encompassing the projecting portions.
